(19) United States
(12) Patent Application Publication
(10) Pub. No.: US 2008/0193207 A1
(43) Pub. Date: Aug. 14, 2008

(54) Ball and Socket Joint with a Sensor Means and Process for Detecting Tightness

(76) Inventors: Jochen Kruse, Osnabruck (DE); Joachim Spratte, Osnabruck (DE); Michael Klank, Osnabruck (DE)

Correspondence Address: MCGLEW & TUTTLE, PC, P.O. BOX 9227, SCARBOROUGH STATION, SCARBOROUGH, NY, 10510-9227, US

(21) Appl. No.: 11/917,380

(22) PCT Filed: Jun. 14, 2006
(86) PCT No.: PCT/DE2006/001018

§ 371 Date: Dec. 13, 2007

(30) Foreign Application Priority Data
Jun. 15, 2005 (DE) 10 2005 027 825.6

(51) Int. Cl. F16C 11/06; G05B 11/36

(52) U.S. Cl. 403/133; 700/13

(57) ABSTRACT

A ball and socket joint, for example, for an axle system of a motor vehicle. The ball and socket joint has an essentially ring-shaped or pot-shaped joint housing (1), in the essentially cylindrical interior space of which a ball shell (3) is arranged. The ball (4) of a ball pivot is accommodated in the ball shell (3) in a slidingly movable manner. The ball and socket joint has, furthermore, a sealing bellows (6) as well as a sensor means for monitoring the tightness of the ball and socket joint.

### CROSS REFERENCE TO RELATED APPLICATION

This is a continuation of and claims the benefit (35 U.S.C. §120 and 365(c)) of copending International Application PCT/DE2006/001018 of 14 Jun. 2006, which designated inter alia the United States and which claims the priority of German Application DE 10 2005 027 825 of 15 Jun. 2005. The entire contents of each application is hereby incorporated by reference in its entirety.

### FIELD OF THE INVENTION

The present invention pertains to a ball and socket joint with a sensor means for monitoring the tightness, especially for an axle system or a wheel suspension of a motor vehicle. The ball and socket joint has an essentially ring-shaped or pot-shaped joint housing, in the essentially cylindrical interior space of which a ball shell is arranged. The ball of a ball pivot is accommodated in the ball shell in a slidingly movable manner. The ball and socket joint having, furthermore, a sealing bellows between the joint housing and the ball pivot. The present invention pertains, furthermore, to a process for detecting tightness on a ball and socket joint.

### BACKGROUND OF THE INVENTION

Ball and socket joints of the type mentioned in the introduction are used, for example, but by no means exclusively, on the chassis or on the wheel suspension of motor vehicles. The ball and socket joints of this class comprise a sensor means, with which the tightness of the sealing bellows of the ball and socket joint can be monitored. Timely detection of leaks at the sealing bellows of ball and socket joints is of decisive significance especially where ball and socket joints are safety-relevant components. This is especially true in the area of the chassis or the steering of motor vehicles, where failure of a ball and socket joint during travel may have fatal consequences.

The frequent temperature changes and stone chips, the effects of various operating materials and salt water, as well as the permanent mechanical load, which occur, for example, during the operation of a motor vehicle, may cause the sealing bellows of ball and socket joints to become porous, cracked or even leaky over time. Water, salt water or other corrosive chemical substances may subsequently enter, which may lead to rapid corrosion and to subsequent failure of the joint.

Thus, unless a damaged sealing bellows is detected and replaced in a very short time, corrosion of the joint ball and associated failures and, at any rate, situations that are critical for safety will soon develop as a consequence of the penetration of harmful substances. If, on the other hand, a sealing bellows that has become leaky can be detected in time, such situations, which are alarming with respect to the driving safety of a motor vehicle, can be effectively prevented.

Furthermore, such a means for detecting the tightness of the sealing bellows of a ball and socket joint is, for example, also suitable for use in tests in the phase of development of the ball and socket joint. The tightness of the elastomer bellows can be constantly monitored in this connection, for example, during a test run in the climatic chamber, which may not be accessible during the test. In addition, the point in time at which the first damage occurs can be exactly determined in this manner, which facilitates and improves the accurate analysis of the test results.

A ball and socket joint with a means for detecting leaks on the sealing bellows is known, for example, from DE 103 47 814. This ball and socket joint has a moisture sensor built into the ball and socket joint for detecting leaks of the sealing bellows. The moisture sensor is used to detect, e.g., water having penetrated through the sealing bellows, which has developed a leak, and then to prompt the sending of a warning signal.

However, the use of a moisture sensor to detect leaks of the sealing bellows is not without problems, because moisture sensors have the drawback of being sensitive, for example, to salt water and lubricating greases. According to the teaching of the said document, an attempt is made at counteracting this problem by accommodating the moisture sensor in such a way that it is partially uncoupled or separated from the interior space of the ball and socket joint, while the connection between the moisture sensor and the interior space of the joint is guaranteed through a narrow gap only.

However, this leads to a delay in the response characteristic of the moisture sensor. Moreover, complete encapsulation of the moisture sensor against harmful substances is not possible, because moisture that has penetrated the sensor in case of damage can no longer reach the sensor in this manner, and the leak would therefore also no longer be detected, either.

### SUMMARY OF THE INVENTION

This object is accomplished by a ball and socket joint having a sensor comprise a pressure sensor and with a process for determination of the pressure gradient in the interior space of the sealing bellows during a tilting or pivoting motion of the ball pivot in the joint housing. The process compares the value of the pressure gradient with a desired value; sends a warning in case the actual value drops below the desired value. Preferred embodiments are the subject of the subclaims.

The ball and socket joint according to the present invention comprises, at first, in a manner known per se, an essentially ring-shaped or pot-shaped joint housing. The joint housing has an essentially cylindrical interior space, in which the ball shell of the ball and socket joint is arranged. The ball of the ball pivot of the ball and socket joint can be accommodated in the ball shell in a slidingly movable manner. In a manner that is also known per se, the ball and socket joint comprises, furthermore, a sealing bellows, which closes the pivot-side opening between the joint housing and the ball pivot in an elastically movable manner, as well as a sensor means for monitoring the tightness of the interior space of the joint or of the sealing bellows.

However, the ball and socket joint is characterized according to the present invention in that the sensor means comprises a pressure sensor.

The use of a pressure sensor is advantageous because pressure sensors may be designed as mechanically and chemically highly inert and robust sensors, without the sensitivity of measurement of the pressure sensor being appreciably compromised hereby. The background for the use of a pressure sensor is that the applicant has found that any leaks of the sealing bellows can also be detected with high precision and reliability even with a pressure sensor and precisely with a pressure sensor.

As was found, this is linked with the fact that the sealing bellows is deformed during each pivoting or tilting motion of the ball pivot in relation to the joint housing in such a way that the volume enclosed by the sealing bellows changes. If the sealing bellows is not damaged now and there is complete tightness of the ball and socket joint, this change in volume also leads directly to a change in pressure in the interior space of the sealing bellows or the ball and socket joint.

If, on the other hand, the ball and socket joint or especially the sealing bellows is leaky, a pressure equalization can take place with the environment in the ball and socket joint during the pivoting or tilting motion of the ball pivot in respect to the changes in the volume enclosed in the sealing bellows.

However, this means that the pressure sensor of the ball and socket joint no longer records any changes in pressure in the ball and socket joint in such a case, or, at any rate, it does not record such great changes in pressure in the ball and socket joint, from which leaking of the ball and socket joint or at least of the sealing bellows can in turn be inferred at a high level of certainty. The wear measurement is interfered with by variations in the atmospheric air pressure, because the latter takes place over several hours in the long-term range, whereas the pressure changes induced by tilting motions of the ball and socket joint take place in the range of only a few seconds or even within fractions of one second.

Where and how the pressure sensor is arranged at the ball and socket joint is at first irrelevant for the embodiment of the present invention. The pressure sensor may be arranged, for example, in the area of the sealing bellows or at the joint ball. According to a preferred embodiment of the present invention, the pressure sensor is arranged, however, at the joint housing. This is advantageous in the sense that the pressure sensor as well as the lines leading to the pressure sensor can be arranged in an especially simple manner, in a robust form and thus reliably in this case.

The pressure sensor is preferably arranged in the area of the housing cover of the joint housing, and it is made especially preferably in one piece with the housing cover or is cast with the housing cover. An especially compact, robust and tight connection is thus achieved between the pressure sensor and the joint housing. In addition, the pressure sensor connected to the housing cover is especially simple and therefore it can be mounted on the ball and socket joint at a low cost.

To additionally protect the pressure sensor from the corrosive media, for example, salt water, that are present in the ball and socket joint or may have entered the ball and socket joint, provisions are made according to another, preferred embodiment of the present invention for the pressure sensor to be separated from the interior space of the joint housing by a membrane. Contrary to the moisture sensors known from the state of the art, the pressure sensor can thus be hermetically isolated from the interior space of the ball and socket joint, but without the sensitivity of detection of leaks being appreciably compromised.

To increase the speed of response of the pressure sensor, at least one pressure-equalizing hole is provided between the interior space of the sealing bellows and the cover side of the interior space of the joint housing according to another, preferred embodiment of the present invention. Thanks to the pressure-equalizing hole, the propagation of pressure changes from the interior space of the sealing bellows arranged on the pivot side to the pressure sensor arranged on the housing cover side, which propagation is necessary for the detection of leaks, can take place practically without a time delay. Changes in pressure taking place rapidly can thus be detected with high sensitivity, especially if there is no bearing clearance between the joint ball and the joint shell, or if the ball shell has no oil grooves, through which changes in pressure could propagate.

Leaks at the ball and socket joint can be detected, in principle, already from the fact that no rapid pressure changes are recorded in the ball and socket joint any longer over a certain period of time, for example, during a certain number of operating hours of a motor vehicle, because it can be inferred from this that despite the corresponding tilting or pivoting motions of the ball and socket joint, which can be expected to occur with certainty during several operating hours, the pressure changes that are normally associated herewith in the interior space of the ball and socket joint have not taken place, which can already be considered to be a reliable sign of leak of the ball and socket joint.

To improve and expedite the detection of the leaks even more and to further increase the reliability of detection, provisions are made according to another, preferred embodiment of the present invention for the ball and socket joint to have another sensor means. The additional sensor means is used to determine the tilt angle position of the ball pivot relative to the joint housing.

The signals of the additional tilt angle sensor can thus also be used to obtain especially accurate information on the tightness of the ball and socket joint, because a certain tilt angle position of the ball pivot in the joint housing is always associated, as the applicant has discovered, with a certain change in pressure in the interior space of the joint housing, which takes place approximately in phase, as long as there are no leaks. Consequently, if, for example, the tilt angle sensor reports a certain tilt angle between the ball pivot and the joint housing, and the signal of the pressure sensor, which is to be expected at this tilt angle, fails to appear, the fact of a leak can be immediately inferred with a high degree of reliability.

The present invention pertains, furthermore, to a process for detecting tightness on a ball and socket joint with a sealing bellows, wherein the ball and socket joint has a pressure sensor.

The pressure gradient in the interior space of the ball and socket joint or of the sealing bellows during a tilting motion of the ball pivot in the joint housing is determined for this in a first process step. The value of the pressure gradient is subsequently compared to a desired value, and when the actual value is below the desired value, a warning is sent about a possible leak.

The manner in which it is determined whether a tilting motion of the ball pivot has taken place is at first irrelevant for embodying the process according to the present invention. For example, statements can already be made on the probability of tilting motions during a certain operating time of the ball and socket joint on the basis of statistical relationships, so that a leak of the ball and socket joint can already be inferred with a high degree of certainty in case corresponding pressure gradient measured values fail to appear.

According to another embodiment of the process according to the present invention, the tilting motion of the ball pivot is detected in the first process step on the basis of measured data on the driving state of the motor vehicle. This may be, for example, but by no means exclusively, the steering lock angle, the spring deflection path, data concerning the pitching or rolling motion of the vehicle body, and/or vehicle dynamics data.

According to another, preferred embodiment of the process according to the present invention, the tilting motion of the ball pivot is detected in the first process step by means of an additional sensor means arranged at the ball and socket joint or in the ball and socket joint. The sensor means has at least one tilt angle or position sensor for determining the relative position or the relative angle between the ball pivot and the joint housing.

Thanks to the additional sensor means, it is possible to determine the point in time at which the ball and socket joint is subject to a tilting motion, which is so great that a pressure change taking place simultaneously with the tilting motion would have to occur in the interior space of the sealing bellows, or in the interior space of the joint housing, in case of an undamaged sealing bellows. If the internal pressure does not change in the joint housing or in the interior space of the sealing bellows in such a case in the expected, characteristic manner or to the expected, characteristic extent, damage to the sealing bellows can be immediately inferred at a high level of certainty and the corresponding warning can be sent.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a longitudinal sectional view through a ball and socket joint according to the present invention in a schematic view.

### DESCRIPTION OF THE PREFERRED EMBODIMENT

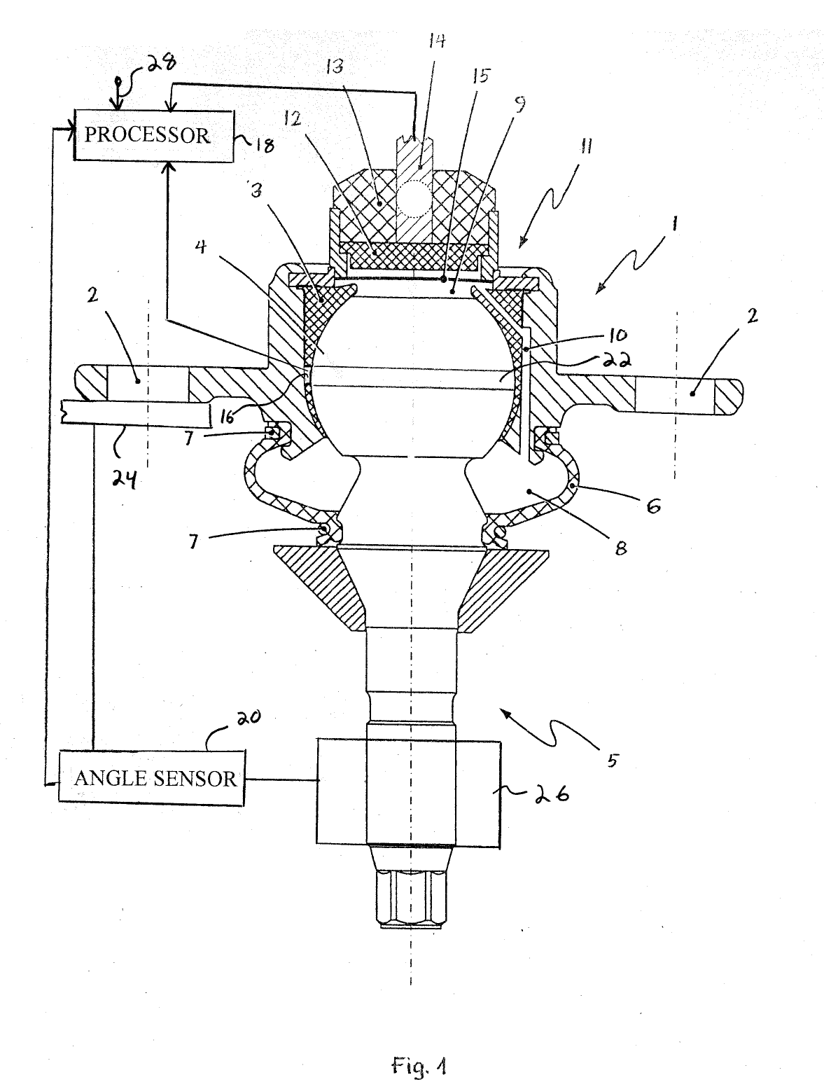

Referring to the drawings, FIG. 1 shows, in a schematic longitudinal section, an embodiment of a ball and socket joint according to the present invention. The essentially pot-shaped joint housing 1 with fastening flanges 2 as well as with the joint shell or ball shell 3 arranged in the joint housing are detected at first. The ball 4 of a ball pivot 5 is in turn arranged in the interior space of the ball shell 3.

Furthermore, an elastomer sealing bellows 6 is shown, which is connected to the shaft of the ball pivot 5 as well as to a groove on the joint housing 1 by means of lock washers 7 in such a way that it is tightly in contact with the shaft. The sealing bellows 6 encloses in its interior space 8 a certain volume, which may be filled, in general, with air, or partly also with a lubricant. As has been found, a change (mostly a reduction) occurs in the volume 8 enclosed in the interior space of the sealing bellows 6 during pivoting motions of the ball pivot 5 in relation to the joint housing 1 because of the deformation of the sealing bellows 6, and this change increases with increasing pivot angle deflection of the ball pivot 5 in relation to the joint housing 1.

However, this change in the volume 8 contained in the sealing bellows 6 is inevitably associated with a corresponding change in pressure, as long as the sealing bellows 6 and the ball and socket joint have no leaks or damage.

Since the ball and socket joint shown in the figure has no oil grooves in the ball shell 3, through which the pressure changes could propagate from the interior space of the sealing bellows 8 into the head space 9 of the joint housing 1, the joint housing 1 is provided with at least one pressure-equalizing hole 10, which continuously connects the interior space 8 of the sealing bellows 6 to the head space 9 of the joint housing 1.

The pressure changes in the interior space 8 of the sealing bellows 6 can thus directly propagate into the head space 9 of the joint housing 1, where the pressure changes can be recorded by the pressure sensor 12 arranged in the area of the housing cover 11 without a time delay. In the exemplary embodiment being shown, the pressure sensor 12 (indicated only schematically) is connected to a part of the housing cover 11 firmly and in a sealingly closing manner by means of a pourable sealing compound 13. The pourable sealing compound 13 also firmly and reliably encloses the feeder cable 14, which connects the pressure sensor 12 to a corresponding electrical analysis unit (not shown).

The arrangement of the pressure sensor 12 at or in the housing cover 11 is also advantageous because existing ball and socket joints can thus be equipped with a pressure sensor 12 or with the sealing detection means according to the present invention without or with only slight modifications.

A flexible membrane 15 is arranged between the head space 9 of the joint housing 1 and the pressure sensor 12 for the additional protection of the pressure sensor 12 against the lubricants contained in the ball and socket joint or from corrosive substances that may have penetrated, for example, salt water. The membrane 15 hermetically seals the pressure sensor 12 against the head space 9 of the joint housing 1 and thus protects it completely against contamination or chemically corrosive substances, without the sensitivity of tightness detection being appreciable compromised hereby.

The angle between the ball pivot 5 and the joint housing 1 can be measured with an angle sensor 16 that is arranged in the bearing shell 3 or the joint housing 1. The angle sensor 16 can work in cooperation with a magnet 22 arranged in the ball 4 of the ball pivot 5. An alternative angle sensor 20 can also be connected to different parts of the vehicle 24, 26 which are connected to the joint housing 1 and the ball pivot 5 respectively. It is still further possible to determine the angular orientation of the ball pivot 5 with respect to the joint housing 1 by a data input 28 received from other systems of the motor vehicle.

A processor 18 receives the measured values of the pressure and angle, and compares this with a desired relationship between the pressure and angle. If the measured relationship and the desired relationship are not similar, in particular if the measured relationship is lower than the desired relationship, a warning or discrepancy is indicated.

Consequently, it becomes clear as a result that thanks to the present invention, a ball and socket joint is provided, which makes it possible to immediately and reliably detect leaks, especially those resulting from damage to or aging phenomena on the sealing bellows. The risk for damage to the sensor used to detect the wear due to operating materials or substances that have penetrated is ruled out completely, unlike in the state of the art. Thus, the present invention makes a valuable contribution to the improvement of the safety, reliability and failure prevention of ball and socket joints, especially in respect to use in the area of demanding axle systems and wheel suspensions on the motor vehicle.

While a specific embodiment of the invention has been shown and described in detail to illustrate the application of the principles of the invention, it will be understood that the invention may be embodied otherwise without departing from such principles.

### APPENDIX

### LIST OF REFERENCE NUMBERS

1 Joint housing
2 Mounting flange
3 Ball shell
4 Joint ball
5 Ball pivot
6 Sealing bellows
7 Lock washer
8 Sealing bellows interior space
9 Joint housing head space
10 Pressure-equalizing hole
11 Housing cover
12 Pressure sensor
13 Pourable sealing compound
14 Feeder cable
15 Membrane

1-11. (canceled)

12. A ball and socket joint arrangement comprising:
a joint housing defining a cylindrical interior space;
a ball shell in said interior space;
a ball pivot with a ball arranged in said ball shell in a slidingly movable manner;
a sealing bellows between said joint housing and said ball pivot;
a pressure sensor measuring a bellows pressure inside said sealing bellows.

13. A ball and socket joint in accordance with claim 12, wherein:
said pressure sensor is arranged at said joint housing.

14. A ball and socket joint in accordance with claim 12, wherein:
said joint housing includes a housing cover on an end of said housing diametrically opposite said sealing bellows;
said pressure sensor is arranged in an area of said housing cover of said joint housing.

15. A ball and socket joint in accordance with claim 14, wherein:
said pressure sensor is made in one piece with said housing cover or is embedded in said housing cover by casting.

16. A ball and socket joint in accordance with claim 12, wherein:
said pressure sensor is separated from said interior space of said joint housing by a membrane.

17. A ball and socket joint in accordance with claim 12, wherein:
one of bearing shell and said joint housing define a pressure-equalizing hole between a volume inside said sealing bellows and a portion of said interior space of said joint housing diametrically opposite said sealing bellows.

18. A ball and socket joint in accordance with claim 12, further comprising:
an additional sensor means for determining a pivot angle position of said ball pivot relative to said joint housing.

19. A ball and socket joint in accordance with claim 18, wherein:
said additional sensor means comprises at least one pivot angle sensor operating in a contactless manner.

20. A process for detecting leaks in a ball and socket joint, the process comprising the steps of:
providing a joint housing defining an interior space;
providing a ball pivot with a ball pivotally accommodated in said interior space;
providing a sealing bellows connected to said ball pivot and to said joint housing, said sealing bellows enclosing a volume with said ball pivot and said joint housing;
measuring a pressure gradient of said volume.

21. A process in accordance with claim 20, further comprising:
determining a pivoting motion of said ball pivot in said joint housing;
comparing a measured relationship of the measured pressure gradient to the measured pivoting motion with a desired relationship of the pressure gradient to the pivoting motion;
sending a warning measured relationship is below the desired relationship.

22. A process in accordance with claim 21, wherein:
said ball pivot and said joint housing are is installed in a vehicle;
said determining of the pivoting motion of said ball pivot is performed on a basis of a driving state of the vehicle.

23. A process in accordance with claim 21, wherein:
said determining of the pivoting motion of said ball pivot is carried out with at least one tilt angle sensor arranged at or in the ball and socket joint.

24. A ball and socket arrangement comprising:
a joint housing defining an interior space;
a ball shell arranged in said interior space of said joint housing;
a ball pivot with a ball pivotally accommodated in said ball shell;
a sealing bellows connected to said ball pivot and to said joint housing, said sealing bellows enclosing a volume with said ball pivot and said joint housing;
a pressure sensor measuring a bellows pressure of said volume.

25. An arrangement in accordance with claim 24, further comprising:
an angle sensor measuring a pivot angle between said ball pivot and said joint housing;
a processor containing a desired relationship between the bellows pressure of said volume and the pivot angle, said processor determining a measured relationship between the bellows pressure and the pivot angle, said processor comparing said measured relationship with said desired relationship, said processor indicating a discrepancy when said measured relationship is not similar to said desired relationship.

26. An arrangement in accordance with claim 25, wherein:
said angle sensor directly measures the pivot angle between said ball pivot and said joint housing.

27. An arrangement in accordance with claim 25, wherein:
said joint housing and said ball pivot are connected to different parts of a vehicle;
said angle sensor measures relative movement between said different parts of the vehicle.

28. An arrangement in accordance with claim 25, wherein:
said joint housing and said ball pivot are arranged in a vehicle;
said angle sensor determines the pivot angle from operation of the vehicle.

29. An arrangement in accordance with claim 25, further comprising:
an angle sensor measuring a change in a pivot angle between said ball pivot and said joint housing;
a processor containing a desired relationship between changes in the pivot angle and changes in the bellows pressure, said processor determining a measured relationship between the changes in the pivot angle and the bellows pressure, said processor comparing said measured relationship with said desired relationship, said processor indicating a discrepancy when said measured relationship is not similar to said desired relationship.
